(19) United States
(12) Patent Application Publication
(10) Pub. No.: US 2013/0338911 A1
(43) Pub. Date: Dec. 19, 2013

(54) Vehicle Load and Tracking Device

(71) Applicant: Jose L. Oseguera, Downey, CA (US)

(72) Inventor: Jose L. Oseguera, Downey, CA (US)

(21) Appl. No.: 13/527,325

(22) Filed: Jun. 19, 2012

(51) Int. Cl. G06F 7/00

(52) U.S. Cl. 701/124

(57) ABSTRACT

The vehicle load and tracking device features at least a pair of airbags selectively installed on a rear suspension of an existing vehicle to be monitored, a sensor included with each airbag, the sensor configured to detect a load change information of the airbag, a transceiver, the transceiver in receipt of the load change information from the sensors, the transceiver further having a mounting provision, an audio output, a memory, the transceiver receiving the load change information, noting a time of load change information, and audibly outputting the load change information, a GPS unit in communication with the transceiver, a display within the GPS unit, whereby the GPS display receives and displays the load change information, a plurality of times of load change information, and a location and progress of the existing vehicle.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Monitoring a load on a given truck, especially trucks such as tow trucks and cement trucks, for example, is advantageous for many obvious reasons. Additionally, monitoring a trucks travel provides advantages for both a customer and a provider. The present device provides these advantages.

### FIELD OF THE INVENTION

The vehicle load and tracking device relates to vehicular weight monitoring and to vehicle path and distance monitoring.

### SUMMARY OF THE INVENTION

The general purpose of the vehicle load and tracking device, described subsequently in greater detail, is to provide a vehicle load and tracking device which has many novel features that result in an improved vehicle load and tracking device which is not anticipated, rendered obvious, suggested, or even implied by prior art, either alone or in combination thereof.

To attain this, the vehicle load and tracking device provides information regarding load changes to an existing vehicle. The existing vehicle may include a tow truck, cement truck, cab, or any of a host of vehicles from which an operator might find load change information useful. The device further includes an airbag or a pair of airbags or even more airbags that may be installed on a vehicle, such as on the vehicle's rear suspension. The airbags each further comprise one of the sensors to detect load change. The transceiver of the device may be in communication with the sensors wirelessly or may be hardwired to the sensors. The transceiver may audibly inform an operator of load change information. A memory is included in the transceiver to record time of load changes as well as mass of load changes. The transceiver may be mounted to a vehicle in a plurality of ways. The GPS unit of the device is in communication with the transceiver. The GPS unit includes a display for informing the user of the device of load change information and time of day and time durations of load changes. The GPS unit also informs the user with tracking information of vehicle location and path of travel at any chose time or within any chosen time frame. Airbag use in sensing load change has been found to be superior to hydraulics.

As an example of use, the device may be installed on a tow truck. The device informs a user of load change of the tow truck, such as when a towed vehicle is partially or fully engaged with the tow truck. The device may then record and inform a user of the duration of load change, tow truck progress during load change, and cessation of load change informing the user that the towed vehicle has been disengaged.

Thus has been broadly outlined the more important features of the improved vehicle load and tracking device so that the detailed description thereof that follows may be better understood and in order that the present contribution to the art may be better appreciated.

An object of the vehicle load and tracking device is to sense vehicle load.

Another object of the vehicle load and tracking device is to record vehicle load.

A further object of the vehicle load and tracking device is to record vehicle load duration.

An added object of the vehicle load and tracking device is to track a vehicle's path and time of travel.

And, an object of the vehicle load and tracking device is to sense vehicle load via pneumatics.

These together with additional objects, features and advantages of the improved vehicle load and tracking device will be readily apparent to those of ordinary skill in the art upon reading the following detailed description of presently preferred, but nonetheless illustrative, embodiments of the improved vehicle load and tracking device when taken in conjunction with the accompanying drawings.

### BRIEF DESCRIPTION OF THE DRAWINGS

FIG. 1 is a front elevation view of the sensor, transceiver, and GPS unit.

FIG. 2 is a perspective view of the transceiver.

FIG. 3 is a lateral view of an exemplary pair of vehicles that benefit from the device.

FIG. 4 is a perspective view of the installed airbag with sensor and transceiver.

### DETAILED DESCRIPTION OF THE DRAWINGS

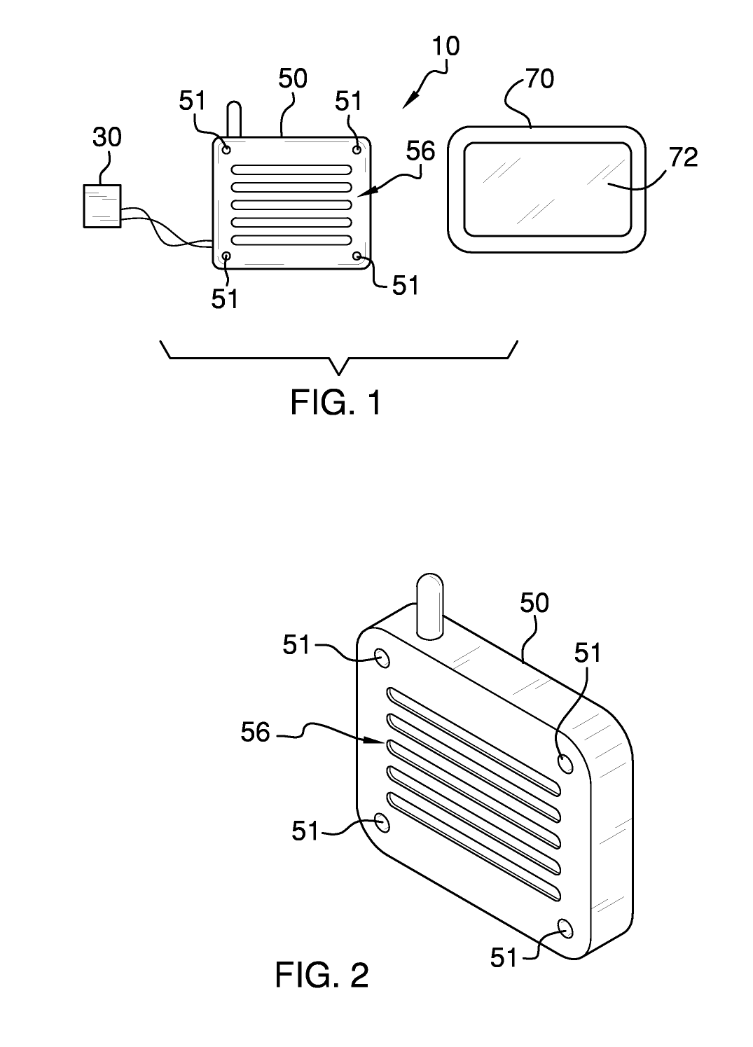

With reference now to the drawings, and in particular FIGS. 1 through 4 thereof, the principles and concepts of the vehicle load and tracking device generally designated by the reference number 10 will be described.

Referring to FIG. 4, the device 10 partially comprises an airbag 20 selectively installed on a rear suspension of an existing vehicle 11 to be monitored. A sensor 30 is included with the airbag 20. The sensor 30 is configured to detect a load change information of the airbag 20.

Referring to FIG. 2, a transceiver 50 is provided. The transceiver 50 is in receipt of the load change information from the sensor 30. The transceiver 50 further comprises a mounting provision 51, an audio output 56, and a memory.

Referring to FIG. 1, the transceiver 50 records and audibly signals via the audio output 56 the load change information, and a plurality of times of the load change information. A GPS unit is provided and is in communication with the transceiver 50. The GPS unit 70 further comprises a display 72. The display 72 provides video information to a user regarding a typical GPS unit 70 output. The display also visually informs the user of load change information and the plurality of information from the transceiver 50.

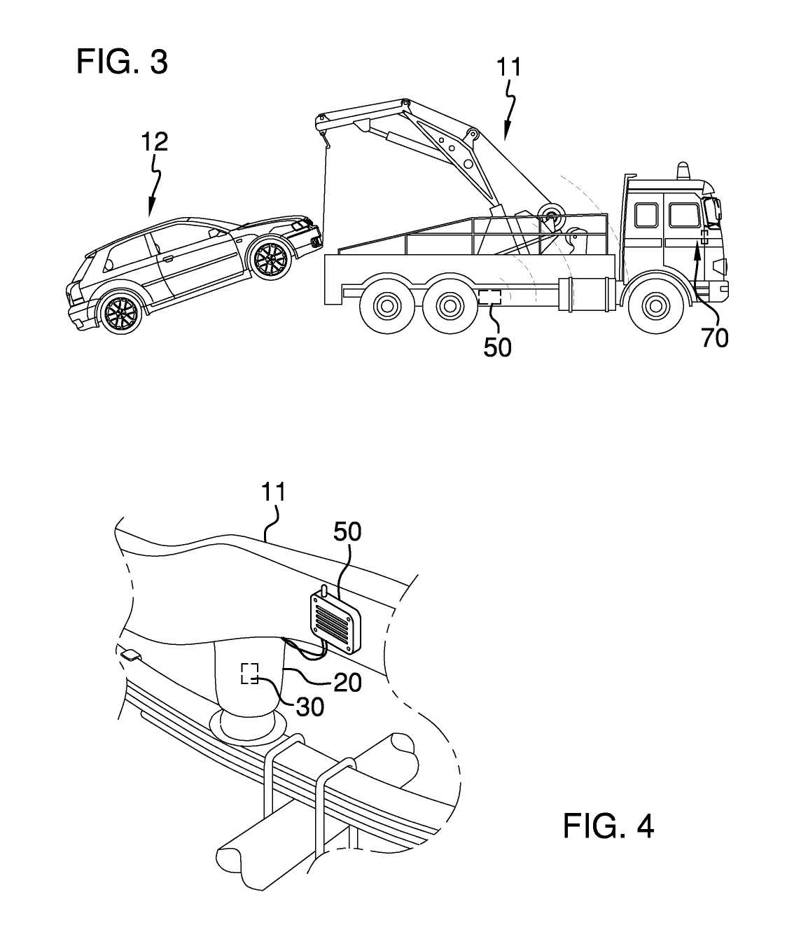

Referring to FIG. 3, the existing vehicle 11 is towing the towed vehicle 12. The transceiver 50 relays information to the GPS unit 70 that may be used within the cab of the existing vehicle 11.

Directional terms such as “front”, “back”, “in”, “out”, “downward”, “upper”, “lower”, and the like may have been used in the description. These terms are applicable to the embodiments shown and described in conjunction with the drawings. These terms are merely used for the purpose of description in connection with the drawings and do not necessarily apply to the position in which the vehicle load and tracking device may be used.

What is claimed is:

1. A vehicle load and tracking device comprising, in combination:
a pair of airbags selectively installed on a rear suspension of an existing vehicle to be monitored;
a sensor included with each airbag, the sensor configured to detect a load change information of the airbag;
a transceiver, the transceiver in receipt of the load change information from the sensors, the transceiver further comprising:
a mounting provision;
an audio output;
a memory;
whereby the transceiver receives the load change information, notes a time of load change information, and audibly outputs the load change information;
a GPS unit in communication with the transceiver;
a display partially comprising the GPS unit;
whereby the GPS display receives and displays the load change information, a plurality of times of load change information, and a location and progress of the existing vehicle.

2. The device according to claim 1 wherein the transceiver and GPS unit are battery powered.

3. The device according to claim 1 wherein the transceiver and GPS unit are powered from an external source.

4. The device according to claim 1 wherein each sensor is in a hardwire communication with the transceiver.

5. The device according to claim 2 wherein each sensor is in a hardwire communication with the transceiver.

6. The device according to claim 3 wherein each sensor is in a hardwire communication with the transceiver.

7. The device according to claim 1 wherein each sensor is in a wireless communication with the transceiver.

8. The device according to claim 2 wherein each sensor is in a wireless communication with the transceiver.

9. The device according to claim 3 wherein each sensor is in a wireless communication with the transceiver.
